(19) United States
(12) Patent Application Publication
(10) Pub. No.: US 2026/0016167 A1
(43) Pub. Date: Jan. 15, 2026

(54) Method of Detecting a Leakage in a Cooking Appliance and Cooking Appliance

(71) Applicant: RATIONAL Aktiengesellschaft, Landsberg am Lech (DE)

(72) Inventors: Fernando MEO, Landsberg am Lech (DE); Maximilian WENNINGER, Landsberg am Lech (DE); Denisa-Beatrice OLARU, Landsberg am Lech (DE)

(21) Appl. No.: 19/262,889

(22) Filed: Jul. 8, 2025

(30) Foreign Application Priority Data
Jul. 12, 2024 (DE) 10 2024 119 872.9

(51) Int. Cl. F24C 3/12; G01M 3/40

(52) U.S. Cl. CPC F24C 3/128; G01M 3/40

(57) ABSTRACT

A method of detecting a leakage in a cooking appliance with a gas burner and a sensor connected to an evaluation unit for exchanging information comprises the following steps. In a first step, the cooking appliance is put into a test state in which the gas burner is not in operation. In a second step, a voltage is applied to the sensor. In a third step, a current is measured at the sensor and a sensor signal is generated which is representative of the current at the sensor. In a fourth step, the sensor signal is sent to the evaluation unit. In a fifth step, the sensor signal is compared in the evaluation unit to a reference value which represents a cooking appliance which has no leakage and in which the gas burner is not in operation.

The invention relates to a method of detecting a leakage in a cooking appliance comprising a gas burner and a sensor, and to a cooking appliance comprising a gas burner, a sensor, and an evaluation unit connected to the sensor for exchanging information.

### CROSS-REFERENCE TO RELATED APPLICATIONS AND PRIORITY

This patent application claims priority from German Patent Application No. 10 2024 119 872.9 filed Jul. 12, 2024. This patent application is herein incorporated by reference in its entirety.

### BACKGROUND OF THE INVENTION

Combustible gas is often used as one of the primary energy sources for cooking appliances. The heat generated by combustion can be used to heat the surfaces of the cooking appliance directly. More commonly, the heat is used in a heat exchanger to heat air, which is then fed into a cooking chamber of the cooking appliance.

To this end, the cooking appliance has a gas burner system which includes an air supply, an air exhaust, a gas supply valve, and a gas burner which has an ignition device including an ignition electrode. Sensors and a control unit are also provided to control the proper operation of the combustion process.

If the gas burner system has a leak, moisture and/or hot cooking media from the cooking chamber can enter the gas burner system and cause damage thereto or to connected components such as the gas burner or fan. In the worst case, the cooking appliance may fail completely if the leaks are not detected and repaired in good time.

Therefore, the object of the invention is to provide a method and an improved cooking appliance by means of which leaks can be detected quickly and reliably to prevent consequential damage to the cooking appliance.

### BRIEF DESCRIPTION OF THE INVENTION

The object is achieved by a method of detecting a leakage in a cooking appliance comprising a gas burner and a sensor which is connected to an evaluation unit for exchanging information. The method according to the invention comprises the following steps: in a first step, the cooking appliance is put into a test state in which the gas burner is not in operation. In a second step, a voltage is applied to the sensor. In a third step, a current is measured at the sensor, and a sensor signal is generated which is representative of the current at the sensor. In a fourth step, the sensor signal is sent to the evaluation unit, and in a fifth step, the sensor signal is compared in the evaluation unit to a reference value which represents a cooking appliance which has no leakage and in which the gas burner is not in operation.

The fundamental idea of the invention is based on the fact that a voltage may be applied to a sensor already present in the cooking appliance and, by means of the sensor signal sent by the sensor, conclusions can be drawn as to whether or not the cooking appliance has a leakage through which moisture has penetrated from the cooking chamber into the gas burner system. According to the invention, no additional sensor needs to be installed in the cooking appliance, as the sensors already present in the cooking appliance can be used for the leakage detection method. The cooking appliance therefore only needs to have an evaluation unit by means of which the method according to the invention can be carried out. This saves costs, for example for the installation of additional sensors. In addition, the method is simple and can be universally implemented in any cooking appliance having a gas burner system, and no special adaptation of the system is required for different cooking appliances. The method can be carried out on any cooking appliance as soon as the evaluation unit is capable of evaluating the received sensor signal.

For this purpose, the evaluation unit analyzes at least one sensor signal. In addition, the evaluation unit may also evaluate further sensor signals from further sensors and/or analyze current appliance data to then determine a potential leakage in the cooking appliance if the measured data deviates from a corresponding reference value. If several sensors are used for leakage detection, all sensors of the cooking appliance are purposefully activated in the test state. The use of different sensors makes it particularly easy to detect a leakage, as there is then a particularly clear difference between the sensor values and the reference values.

To be able to carry out the method according to the invention and to obtain reliable results, the cooking appliance, in the first step, must be put into a test state in which the gas burner is not in operation. In the following, this refers to a state in which the cooking appliance itself is switched on and active, but the gas burner has no flame. However, all further components of the cooking appliance may be in operation without change. The only decisive factor is that there is no flame at the ignition electrode, as would be the case in an operating state. If there is a flame at the ignition electrode, the method cannot reliably detect a leakage.

According to one aspect of the invention, the reference value to which the sensor signal is compared in the fifth step is an absolute value, a maximum value, an average value, an integral value, a value from a trained artificial intelligence (AI) model, from a mathematical operation such as a standard deviation and/or a value from a mathematical transformation such as a Fourier transformation (FT) or a fast Fourier transformation (FFT) of a current at the sensor. The AI models may be trained using raw data or characteristics of the raw data, to detect outliers, for example. The reference value may therefore be either the current flow at the sensor at a specific point in time or within a defined period. Basically, correlations between several values may also be used to serve as a reference value and to reliably confirm or exclude a leakage. Alternatively, the reference value may also be a development of a current over a defined period of time. Depending on the type of sensor signal, i.e., whether the sensor signal is a single measured value or an average value, or even a series of measured values, for example, the currently measured sensor signal is compared to a corresponding reference value.

According to the invention, it is provided that, in the event of a leakage in the cooking appliance, the sensor signal is above or below the reference value, depending on the reference value used. This means that in a cooking appliance having a leakage, a higher current flow occurs at the sensor than for a cooking appliance without a leakage, provided that the same voltage is applied to the sensor in both cases. A leakage therefore leads to a measurably higher current at the sensor. The method is therefore particularly well suited for detecting current values which are “outliers” compared to an intact cooking appliance.

In step e), the sensor signal is compared to a reference value which represents a current of 0 A applied at the sensor. In other words, in a cooking appliance without a leakage, essentially no current flows at the sensor, or at most a very low current caused by an existing inactivity current, while a measurable current flow is detectable at a sensor arranged in a cooking appliance which has a leakage. This is because the moisture which has penetrated due to a leakage generates a measurable current flow at the sensor when a voltage is applied, so that a current can be detected at the sensor.

According to a further aspect of the invention, the voltage is applied to an ignition electrode, which is used here as a sensor for the method according to the invention.

The ignition electrode thus has two functions in the cooking appliance. On the one hand, it serves to generate an ignition spark when a voltage is applied, in particular a high voltage, and thus to ignite the combustion gas-air mixture contained in the gas burner system. On the other hand, according to the invention, this ignition electrode may also serve as a sensor for detecting a leakage in the cooking appliance.

It is therefore not necessary to incorporate additional sensors in the cooking appliance by means of which the leakage test can be carried out. The method according to the invention makes it possible to carry out this leakage test using the ignition electrode already installed.

In addition, the ignition electrode as a sensor offers the advantage of being particularly robust and, due to its position within the gas burner system, of being particularly well protected from many influencing factors. This additionally increases the robustness of the leakage detecting method. A further advantage of using the ignition electrode as a sensor is that, in a cooking appliance which has no leakage and no flame, no or hardly any current flows at low voltage at the ignition electrode, meaning that the reference value is close to zero. Only when the cooking appliance has a leakage does current flow through the sensor when a voltage is applied, so that the measured value is greater than zero. This makes it easy to distinguish in the test state whether a leakage is present or not.

According to a further aspect of the invention, a control unit sends a driving signal to a gas supply valve, a fan wheel, and/or an ignition electrode in the test state so that no flame is present or may be present. The control unit thus ensures that the cooking appliance is switched from the operating state to the test state by either driving and closing the gas supply valve to prevent combustible gases from being introduced into the gas burner system, by stopping the fan wheel so that no air is drawn into the gas burner system, and/or by driving the ignition electrode with a driving signal, after which no high electrical voltage is applied to the ignition electrode.

According to the invention, a low voltage is applied to the sensor in step b) in the test state, in particular the voltage is not sufficiently high to ignite a flame. To ignite a flame, a high voltage is usually applied to the ignition electrode so that in the test state, in which there should be no flame at the ignition electrode, the voltage applied to the sensor is less than 1 kV. This prevents an ignition spark from accidentally occurring in the ignition device and igniting a flame, which would result in the method being unable to detect a leakage at all or at least no longer being able to detect it reliably.

According to a further aspect of the invention, the method comprises a step f) in which an error message is generated when a leakage is determined. Advantageously, the error message is displayed on a screen of the cooking appliance. This allows an operator of the cooking appliance to see at a glance that the cooking appliance has a leakage, and the operator can take appropriate precautions to prevent consequential damage to the cooking appliance caused by moisture ingress in good time, and to prevent total failure of the cooking appliance.

According to the invention, in step b), a voltage is applied to the sensor arranged in a combustion chamber of the cooking appliance so that a leakage in the combustion chamber and/or in an adjoining air outlet of the cooking appliance can be detected through the method. This makes it possible to detect in particular leaks at seals of the gas burner system or at defective components. Compared to sensors which are located in the cooking appliance itself, for example, a sensor arranged in the combustion chamber of the cooking appliance may specifically detect leaks in the gas burner system. Leaks affecting other parts of the cooking appliance can however not be detected. The method specifically aims at detecting leaks in the gas burner system or between the gas burner system and the cooking chamber in good time.

According to the invention, a cooking appliance is provided, comprising a gas burner, a sensor and an evaluation unit which is connected to the sensor for exchanging information and is configured and set up to carry out the method according to the invention described above. The evaluation unit makes it possible to carry out the method and thus reliably detect a leakage in the cooking appliance. With the help of the method executed by the cooking appliance and with the evaluation carried out in the evaluation unit, it is not only possible to reliably detect a leakage, it can also be prevented that a cooking appliance without a leakage is incorrectly identified as a defective cooking appliance.

### BRIEF DESCRIPTION OF THE FIGURES

Further advantages and features of the invention will become apparent from the description below and the drawings to which reference is made and in which:

FIG. 1 shows a schematic view of a cooking appliance according to the invention;

FIG. 2 shows a schematic view of a gas burner system of the cooking appliance of FIG. 1;

FIG. 3 shows a schematic view of a gas burner system of FIG. 2 with leakages;

FIG. 4 shows a schematic view of a combustion chamber of the gas burner system of FIG. 2; and

FIG. 5 shows a schematic sequence of a method according to the invention of detecting leakages in the cooking appliance of FIG. 1.

### DETAILED DESCRIPTION OF THE FIGURES

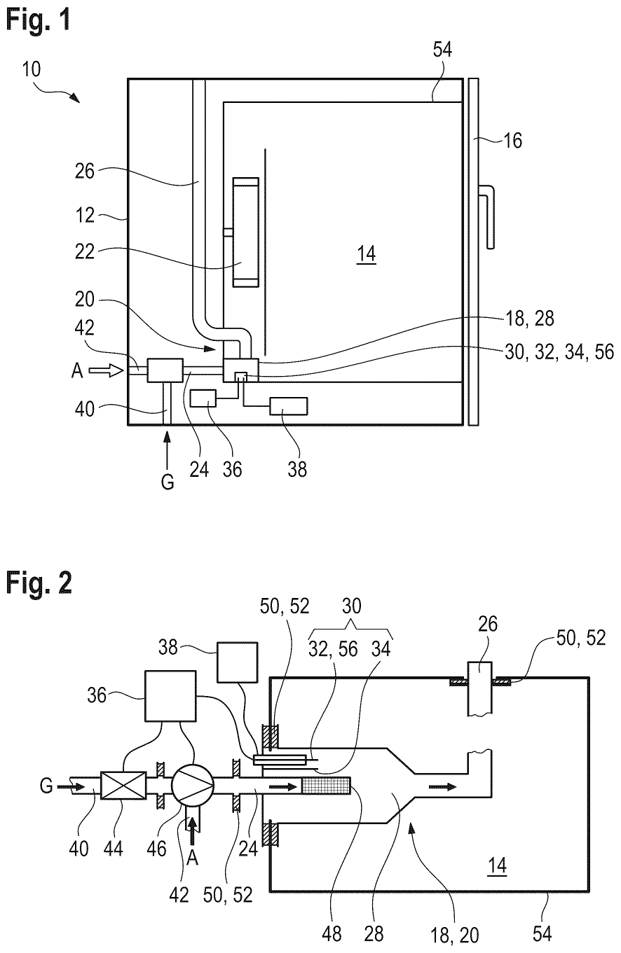

FIG. 1 schematically shows a gas appliance 10. It comprises a housing 12, a cooking chamber 14, and a door 16 which allows access to the cooking chamber 14. Food can be cooked in the cooking chamber 14 using hot air, steam, or a mixture of hot air and steam. In addition, microwaves can be introduced into the cooking chamber 14 to support the cooking process.

A gas burner 18 which is shown schematically and heats the air present in the cooking chamber 14 is provided to supply hot air. For this purpose, a schematically shown heat exchanger 20 is provided, through which the air heated by the gas burner 18 transfers its heat to the air in the cooking chamber 14 and thus heats it. The heated air in the cooking chamber 14 can be distributed within the cooking chamber 14 by means of a fan 22.

The gas burner 18 is supplied with combustible gas via a schematically shown air supply 24, which receives combustible gas from a gas supply G and air via a schematically shown air supply A.

The combustible combustion gas-air mixture is introduced into the gas burner 18 and ignited there. The exhaust air produced by combustion is discharged from the cooking appliance 10 via an air exhaust pipe 26.

The gas burner 18 comprises a combustion chamber 28, which is connected both to the air supply 24 and to the air exhaust pipe 26.

An ignition device 30 having an ignition electrode 32 and a ground electrode 34 is arranged inside the combustion chamber 28.

The ignition device 30, in particular the ignition electrode 32, is connected both to a control unit 36 and to an evaluation unit 38 via lines for exchanging information. The ignition device 30 is driven via the control unit 36 so that, for example, an ignition spark is generated between the ignition electrode 32 and the ground electrode 34, by means of which the combustion gas-air mixture inside the combustion chamber 28 can be ignited.

The heated air then flows through the air exhaust pipe 26, which is at least partially located within the cooking chamber 14, and thus heats the air in the cooking chamber 14.

FIG. 2 shows the gas burner system shown schematically in FIG. 1 in detail.

The heat exchanger 20 which is substantially formed by the combustion chamber 28 and at least part of the air exhaust pipe 26 is located in the cooking chamber 14.

A combustion gas-air mixture is introduced into the combustion chamber 28, which is then ignited by means of the ignition device 30.

For this purpose, on the one hand, combustion gas is introduced into the air supply 24 via a combustion gas line 40, and on the other hand, fresh air is introduced into the air supply 24 via a fresh air line 42.

The amount of combustion gas can be controlled by a gas supply valve 44, whereas the amount of fresh air can be controlled by a fan wheel 46. Both the gas supply valve 44 and the fan wheel 46 are driven by the control unit 36.

To start combustion for heating the cooking chamber 14, the gas supply valve 44 is driven by the control unit 36 and opened so that a volume flow of combustion gas is introduced through the combustion gas line 40. In addition, the control unit 36 controls the fan wheel 46 so that a volume flow of fresh air is drawn in via the fresh air line 42 and mixed with the volume flow of combustion gas in the air supply 24. An inflammable combustion gas-air mixture is thus present in the air supply 24 of the combustion chamber 28.

The combustion gas-air mixture produced in this way flows through the gas burner 18 and exits the gas burner 18 via a gas burner head 48 and enters the combustion chamber 28.

In the combustion chamber 28, the introduced combustion gas-air mixture is ignited by means of the ignition device 30.

For this purpose, the ignition electrode 32 is driven by the control unit 36 such that a very high voltage is applied to the ignition electrode 32. This generates an ignition spark between the ignition electrode 32 and the ground electrode 34, which ignites the combustion gas-air mixture, as also shown in FIG. 4.

The exhaust gas produced during combustion is conducted through the air exhaust pipe 26, heats it, and leaves the cooking appliance 10 at the end of the air exhaust pipe 26. The heated air exhaust pipe 26 is used in the area of the heat exchanger 20 to transfer the heat to the air contained in the cooking chamber 14 and thus to warm or heat it.

The air exhaust pipe 26 connects the combustion chamber 28 to the outside of the cooking appliance 10 and is arranged such that the exhaust gases produced during the combustion of the combustion gas-air mixture are conducted out of the cooking appliance 10.

To prevent exhaust gas from the gas burner system from entering the cooking chamber 14 and/or moisture from the cooking chamber 14 from entering the gas burner system and thus the interior of the cooking appliance, the gas burner system is sealed at various points towards the cooking chamber 14.

For this purpose, the air exhaust pipe 26 and the gas burner 18, among others, in particular the combustion chamber 28, have various flanges 50 with associated seals 52.

The flanges 50 and seals 52 serve to connect the air exhaust pipe 26, the gas burner 18, the combustion chamber 28, and the fan wheel 46 to each other and to a cooking chamber wall 54 in an airtight manner.

However, it is basically possible that moisture from the cooking chamber 14 may still penetrate into the gas burner system due to a defect in one of the seals 52 or one of the components of the gas burner system.

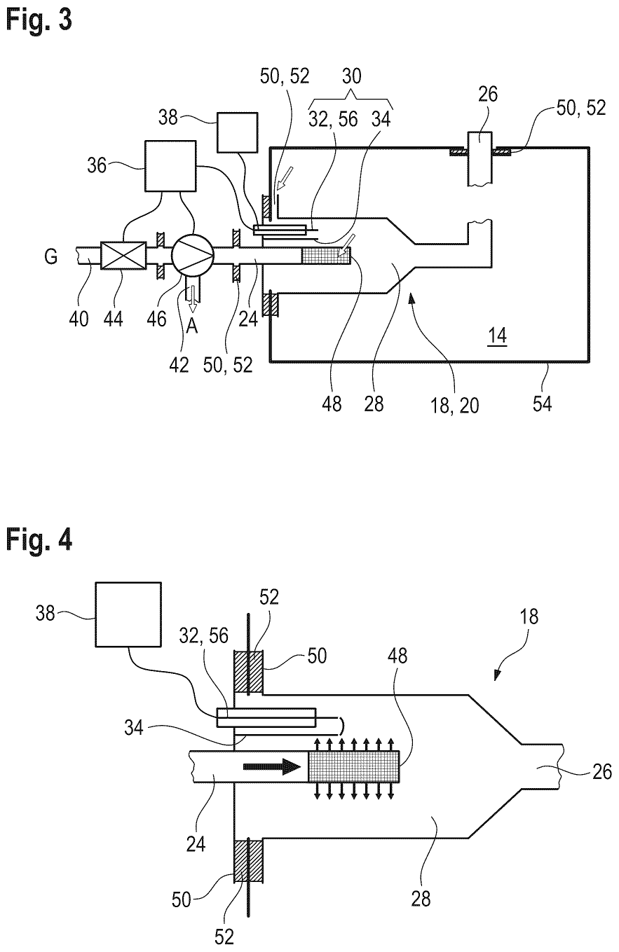

Moisture penetrating from the cooking chamber 14 into the gas burner system and the path of the moisture within the gas burner system are illustrated in FIG. 3 by the various arrows.

In FIG. 3, the seal between the cooking chamber wall 54 and the combustion chamber 28 is defective, so that moisture from the cooking chamber penetrates into the combustion chamber 28 via the flange 50. From there, the moisture further reaches the air supply 24 via the gas burner head 48.

In the air supply 24, the moisture can spread further in the entire gas burner system and escape again, via the fresh air line 42, for example. However, it is also possible that the moisture reaches the control unit 36 or other electronic components of the cooking appliance 10 and causes damage there.

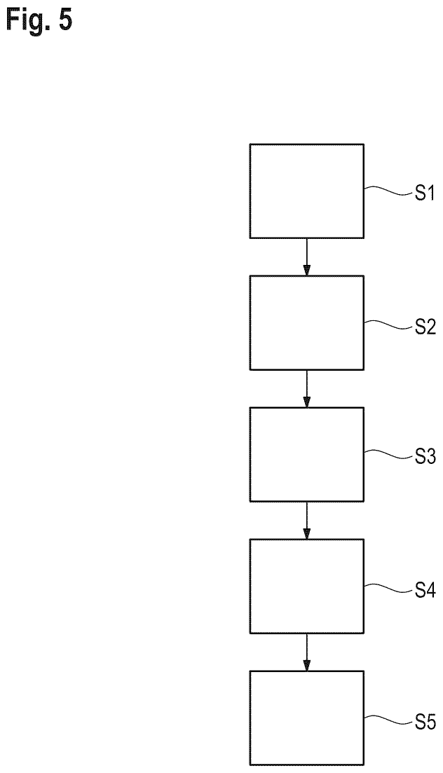

To prevent this, it is very important to detect leaks or leakages in the cooking appliance 10 and, in particular, in the gas burner system in good time. The method shown schematically in FIG. 5 can be used for this purpose.

In a first step S1, the cooking appliance 10 is put into a test state using the control unit 36, in which the gas burner 18 is not active, i.e., no flame is burning in the combustion chamber 28.

During the test state, the ignition electrode 32 serves as a sensor 56 which allows leakages to be detected.

After the cooking appliance has been put into the test state, a low voltage is applied to the sensor 56 in a second step S2, which is so low that no ignition spark is generated between the ignition electrode 32 and the ground electrode 34, but which is high enough such that even a small amount of moisture in the combustion chamber 28 causes a current flow at the sensor 56.

In a third step S3, the control unit 36 now measures the current at the sensor 56 and generates a sensor signal which is representative of the current at the sensor 56.

In a fourth step S4, the sensor signal is transmitted to the evaluation unit 38, where it is evaluated in a fifth step S5.

For evaluation, the sensor signal, which represents the current measured at the sensor, is compared to a reference value.

The reference value is an absolute value, a maximum value, an average value, an integral value, a value from a trained artificial intelligence (AI) model, of a mathematical operation, and/or a value of a mathematical transformation of a current flow occurring at the sensor when the cooking appliance 10 has no leakage, i.e., when no moisture has entered the combustion chamber 28.

Therefore, the reference value is a very small value, in particular the reference value is a current of substantially 0 A, wherein the reference value may also be slightly greater than 0 A due to the inactivity current, i.e., the spontaneous formation of free charge carriers. It is crucial that the reference value is either zero or at least a very small value which takes a small reference current into account, if necessary, as in a cooking appliance 10 which has no leakage and in which no flame is burning, a very high electrical resistance is present between the insulated ignition electrode 32 and the ground electrode 34 and consequently no current or only a very small current such as an inactivity current can flow.

A current flow only occurs at the sensor 56 if either a flame is present in the combustion chamber 28, since ions which migrate are then present between the ignition electrode 32 and the ground electrode 34, or moisture has penetrated into the combustion chamber 28. If neither of these is the case, the current at the sensor 56 is almost 0 A, including a possible inactivity current, through which the current may be slightly greater than 0 A.

If the comparison of the sensor signal with the reference value shows that the sensor signal is above the reference value, for example, when the cooking appliance 10 is in the test state, this is an indication that the gas burner system has a leakage. However, if the sensor signal corresponds to a current close to 0 A, there is no leakage in the cooking appliance 10. Depending on the reference value used, the sensor signal may however also be below the reference value.

If there is a leakage in the cooking appliance 10, an error message can be output on a screen of the cooking appliance 10 in an optional sixth step S6. This informs the user if a leakage is detected in the cooking appliance, in particular in the combustion chamber 28 or in the air exhaust pipe 26.

The detection of leakages via the ignition electrode 32 already present in the cooking appliance 10 is particularly effective, as the ignition electrode 32 is very robust and is also arranged in the cooking appliance 10 so as to be protected from a variety of influencing factors that are present, for example, in the cooking chamber 14. Furthermore, tolerances or other variable marginal conditions have no or only a very minor effect on the current flow at the ignition electrode 32.

In principle, any other ignition electrode 32 or other sensor can be used in the combustion chamber 28 of a cooking appliance 10 to serve as sensor 56, provided that a voltage can be applied thereto and a current can be measured. It is only essential that the cooking appliance 10 has an evaluation unit 38 which is configured and set up to compare the sensor signal to a corresponding reference value. It is also important that the control unit 36 is configured and set up to put the cooking appliance 10 into a test state.

If, in the test state, a sensor signal corresponding to a current of significantly more than 0 A at the sensor 56 occurs in the combustion chamber 28, then a leakage is present, which can be detected using the method shown in FIG. 5.

1. A method of detecting a leakage in a cooking appliance comprising a gas burner and a sensor which is connected to an evaluation unit for exchanging information, the method comprising the following steps:
a) putting the cooking appliance into a test state in which the gas burner is not in operation;
b) applying a voltage to the sensor;
c) measuring a current at the sensor and generating a sensor signal which is representative of the current at the sensor;
d) sending the sensor signal to the evaluation unit;
e) comparing the sensor signal in the evaluation unit to a reference value representing a cooking appliance which has no leakage and in which the gas burner is not in operation.

2. The method of claim 1 wherein the reference value is an absolute value, a maximum value, an average value, an integral value, a value from a trained artificial intelligence model, from a mathematical operation and/or a value from a mathematical transformation of a current at the sensor.

3. The method of claim 1 wherein, in the event of a leakage in the cooking appliance, the sensor signal is above or below the reference value depending on the reference value used.

4. The method of claim 1 wherein in step e), the sensor signal is compared to a reference value which represents a current at the sensor of substantially 0 A or a very low current caused by an inactivity current.

5. The method of claim 1 wherein in step b), a voltage is applied to an ignition electrode.

6. The method of claim 1 wherein, in the test state, a control unit sends a driving signal to a gas supply valve, a fan wheel and/or an ignition electrode so that no flame is present.

7. The method of claim 1 wherein in step b), a low voltage is applied to the sensor, in particular a voltage which is not sufficiently high to ignite a flame, the voltage being particularly preferably less than 1 kV.

8. The method of claim 1 wherein the method comprises a step f) in which an error message is generated when a leakage is detected, in particular the error message is displayed on a screen of the cooking appliance.

9. The method of claim 1 wherein in step b), a voltage is applied to the sensor arranged in a combustion chamber of the cooking appliance so that a leakage in a combustion chamber and/or in an adjoining air exhaust pipe of the cooking appliance is detected using the method.

10. A cooking appliance comprising a gas burner, a sensor and an evaluation unit which is connected to the sensor for exchanging information and is configured and set up to carry out the method according to claim 1.
